(19) United States
(12) Patent Application Publication
(10) Pub. No.: US 2023/0329288 A1
(43) Pub. Date: Oct. 19, 2023

(54) Thawing System and Method

(71) Applicant: YUM! Connect LLC, Louisville, KY (US)

(72) Inventors: Godfrey Bench, Bryanston (ZA); Mohamed Suleman, Bryanston (ZA); Hanlie Deseke, Bryanston (ZA); Xongile Muthambi, Bryanston (ZA); David Mavuso, Ontdekkers Park (ZA); Avesh Ramkirpal, Bromhof (ZA); Nkosingiphile Shelembe, Bryanston (ZA); Phindile Simelane, Bryanston (ZA); Riaan Botha, Bryanston (ZA); Rory Crouch, Bryanston (ZA); Lwandiso Mgwetyana, Montague Gardens (ZA); Nkosi Ndiko, Montague Gardens (ZA); Thabiso Maphumulo, Ottery (ZA); Armanda Luthuli, Bryanston (ZA); Nicolette Samson, Farrarmere (ZA)

(21) Appl. No.: 18/300,179

(22) Filed: Apr. 13, 2023

Related U.S. Application Data
(60) Provisional application No. 63/330,564, filed on Apr. 13, 2022.

(51) Int. Cl. A23L 3/365; A23L 3/00; A23L 3/36; A23B 4/07

(52) U.S. Cl. CPC A23L 3/365; A23L 3/001; A23L 3/363; A23B 4/07

(57) ABSTRACT

A thawing system is provided. The thawing system includes a cabinet having a substantially open front side, a back side, left side panel, right side panel, a top panel, and a substantially open bottom, an interior space of the cabinet defined by the back side, left and right side panels, and the top panel. The thawing system also includes a trolley sized to be received in the interior space of the cabinet, the trolley including a plurality of horizonal rails positioned on inner left and right sides of the trolley and configured to receive a plurality of trays with food stuffs thereon. The thawing system further includes one or more fans mounted adjacent to openings in the back side of the cabinet and configured to force air through the interior space of the cabinet and through the trolley. The thawing system also includes a control system operatively coupled to actuate the fans.

### CROSS-REFERENCE TO RELATED APPLICATIONS

This application is a continuation of U.S. Patent Application No. 63/330,564 filed Apr. 13, 2022 by Godfrey Bench, et al., entitled “Chiller Thawing System and Method”, which is incorporated herein by reference as if reproduced in its entirety.

### STATEMENT REGARDING FEDERALLY SPONSORED RESEARCH OR DEVELOPMENT

Not applicable.

### BACKGROUND

Restaurants and other dining facilities prepare food including meat that may require thawing before preparation.

### SUMMARY

A thawing system is provided. The thawing system includes a cabinet having a substantially open front side, a back side, left side panel, right side panel, a top panel, and a substantially open bottom, an interior space of the cabinet defined by the back side, left and right side panels, and the top panel. The thawing system also includes a trolley that is sized to be received in the interior space of the cabinet, the trolley including a plurality of horizonal rails positioned on inner left and right sides of the trolley and configured to receive a plurality of trays with food stuffs thereon. The thawing system further includes one or more fans mounted adjacent to openings in the back side of the cabinet and configured to force air through the interior space of the cabinet and through the trolley. The thawing system also includes a control system operatively coupled to actuate the fans.

A method for thawing food stuffs is also provided. The method includes providing a thawing unit in a chiller room, the thawing unit including a cabinet and trolley. The method includes providing frozen food onto one or more food trays, inserting the food trays onto rails in the trolley, rolling the trolley into an inner space of the cabinet, and actuating one or more fans. The method includes operating the one or more fans to draw ambient air within the chiller room into the inner space of the cabinet so as to provide air flow about the trays and food stuffs provided on the trays in the trolley, and continuing to operate the fans until the food stuffs are substantially thawed.

### BRIEF DESCRIPTION OF THE DRAWINGS

For a detailed description of various exemplary embodiments, reference will now be made to the accompanying drawings in which:

FIG. 1 is a front perspective view of one embodiment of a chiller thawing unit;

FIG. 2 is a side perspective view of an embodiment of the chiller thawing unit;

FIG. 3 is a perspective view of an embodiment of a trolley;

FIG. 4 is a perspective view of rails of the trolley according to some embodiments;

FIG. 5 is a perspective view of the chiller thawing unit according to some embodiments;

FIG. 6 is a front view of the chiller thawing unit illustrated in FIG. 5;

FIG. 7 is a back view of one embodiment of the chiller thawing unit;

FIG. 8 is a side view of one embodiment of the chiller thawing unit;

FIG. 9 is a back view of another embodiment of the chiller thawing with fans mounted to the back side of the cabinet;

FIG. 10 is a perspective view of an exemplary fan that may be used with some of the disclosed embodiments;

FIG. 11 is a back perspective view of one embodiment of the chiller thawing unit;

FIG. 12 is another back perspective view of one embodiment of the chiller thawing unit;

FIG. 13 is flow chart of a method for thawing frozen food according to one embodiment and

FIG. 14 is a diagram of an exemplary computer system according to some embodiments.

### DETAILED DESCRIPTION

The following discussion is directed to various embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections.

Food may be frozen for safety and other reasons after production for shipment and delivery, for example, to restaurants. Frozen food maybe frozen at temperatures of between −20° C. and −12° C. (degrees Celcius), for example. As previously mentioned, before processing or cooking, most frozen foods need to be thawed in order to be prepared properly. For example, meat that is frozen or not completely thawed may not cook completely and may still be partially raw after cooking. Conversely, meat that is thawed at ambient temperatures within the restaurant may reach unsafe temperatures and may spoil and be unsafe for consumption. For example, food, such as meat, that warms to 5° C. and above may spoil.

Common defrosting methods include cold thawing rooms where frozen food is placed in a room where the temperature is maintained at typically less than 4° C. Air may be circulated throughout the room so that the frozen food defrosts over time without reaching an unsafe temperature once thawed. Cold room thawing has many drawbacks including that the food thaws unevenly depending on the location of the food in the room and the thawing process may take many hours or days. Other methods for thawing food include using cold water, where the frozen food is placed in a bath of cold water for defrosting, or heat thawing such as by using microwaves. However, these solutions may introduce food safety issues, may be inefficient, and costly.

The present disclosure is directed to a system that provides technical advantages to previous methods for thawing frozen foods including providing an easy to use, cost effective system for safely thawing frozen foods that is readily adapted for use in typical restaurants without the need for costly remodeling or refitting of the equipment or systems that currently exist at the restaurant. As used herein, the “food” that may be frozen and thawed may be meat or any other type of food or food stuff that is frozen and requires thawing or defrosting before preparation.

Briefly, the present disclosure provides a chiller thawing unit or system that may be placed in a chiller room where the temperate is typically maintained a 4° C. or less for reasons of food safety. The chiller thawing unit includes a cabinet that has an open front for receiving a trolley within the cabinet. While both the cabinet and trolley may be wheeled for ease of movement, the trolley may be rolled into place or removed from within the cabinet for ease of sliding rows of trays loaded with frozen food into positions within the trolley. Once the trolley is loaded with frozen food, the trolley is placed within the cabinet. The chiller thawing unit's ventilation system may then be activated. The ventilation system may include one or more fans that draw ambient air from the chiller room through the open front of the cabinet, across the spaced apart trays loaded with frozen food in the trolley and cause the air to exit the back or other portions of the cabinet. The chiller thawing unit provides a consistent flow of ambient air drawn evenly across the frozen food loaded on the trays of the trolley which results in a predictable time for uniform thawing of all the frozen food. These and other components of the system and advantages will be discussed in more detail below.

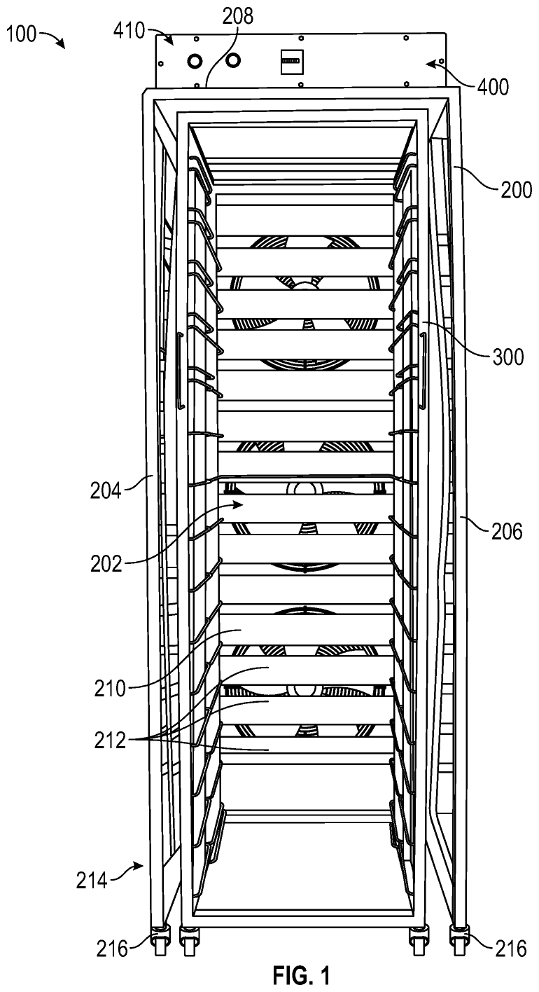

Referring now to FIG. 1, one embodiment of a thawing unit 100 is illustrated. The thawing unit 100 includes a cabinet 200, a trolley 300, and a control system 400. As illustrated in FIG. 1, the trolley 300 is shown positioned within an inner space 202 of the cabinet 200. The inner space 202 is an area defined by a left side panel 204, a right side panel 206, a top panel 208, and a back side 210. The back side 210 may be defined by a plurality of slats 212 that extend from the left side panel 204 to the right side panel 206. The slats 212 may be spaced apart to allow air flow to exit through the back side 210 of the cabinet 200. The cabinet 200 does not include a front panel and instead the cabinet 200 has an open front 214. The top panel 208 extends from the left side panel 204 to the right side panel 206 and from the back side 210 to the open front 214 of the cabinet 200. The cabinet 200 may be provided with a plurality of wheels 216, such as locking casters to enable easy movement to transport and relocate the cabinet 200 to various locations in the restaurant and chiller room. The wheels 216 may be attached along the bottom of the left side panel 204, right side panel 206, and/or back side 210.

The thawing unit 100 may include the control system 400 for controlling operation of the thawing unit 100. The control system 400 may include controls 410 such as switches and controls to power on and off the system, timers, fan speed controls, temperature gauges, and any other controls useful for operation of the thawing unit 100. For example, in the present embodiment the controls 410 include power-on and off switches or buttons. The power-on button actuates the operation of the fans, as will be discussed further below, while the power-off button turns the fans off.

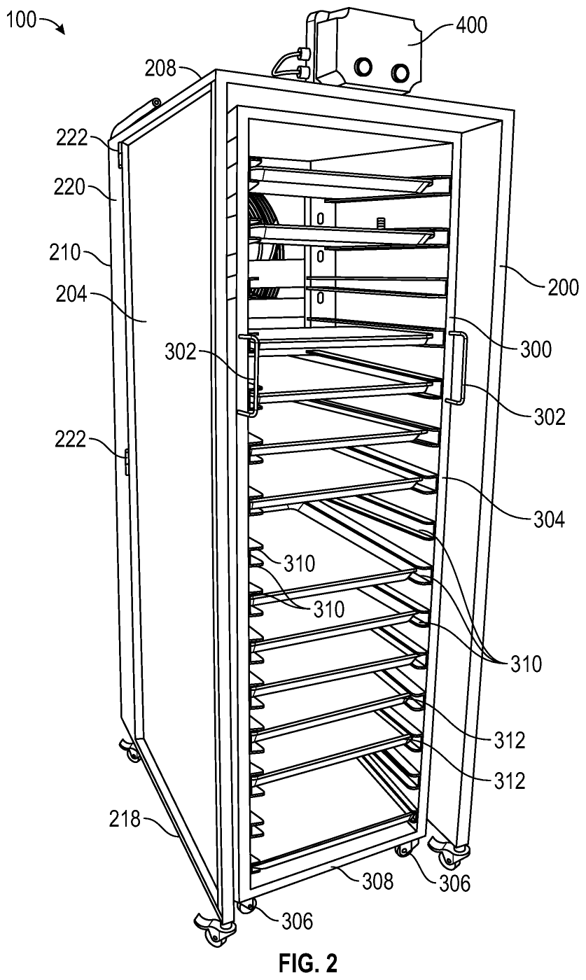

Referring also to FIG. 2, a side perspective view of the thawing unit 100 is illustrated. As can be seen, the left side panel 204 is a uniform wall structure that extends from the top panel 208 and defines a bottom 218 of the cabinet 200. The right side panel 206 is similarly configured. In other embodiments, the left and right side panels 204, 206 and/or top panel 208 may not be a solid walled enclosure but instead may include holes or openings or may be omitted all together such that these structures are merely frames in order to provide for additional air flow throughout the cabinet 200 to promote quicker and more uniform thawing of food.

The components of the thawing unit 100 such as the cabinet 200 and trolley 300, including the left and right side panels 204, 206, top panel 208, and back side 210 structures may be constructed of various materials such as, but not limited to, metallic and/or polymeric materials, or any other suitable material. In the present embodiment, these components are constructed of stainless steel.

As can be seen in FIG. 2, the back side 210 of the cabinet 200 may also include a door 220 attached to the left side panel 204 via hinges 222 to allow the door 220 to be opened. The back side 210 will be discussed in greater detail below.

Similar to the cabinet 200, the trolley 300 may also be provided with wheels 306, located along a bottom 308 of the trolley 300. The wheels 306 may be casters or other wheels similar to wheels 216. The trolley 300 also includes handles 302 attached to a front 304 of the trolley 300 to allow users to easily control movement of the trolley 300 into and out position in the cabinet 200, as well as, to roll the trolley 300 elsewhere in the restaurant as needed.

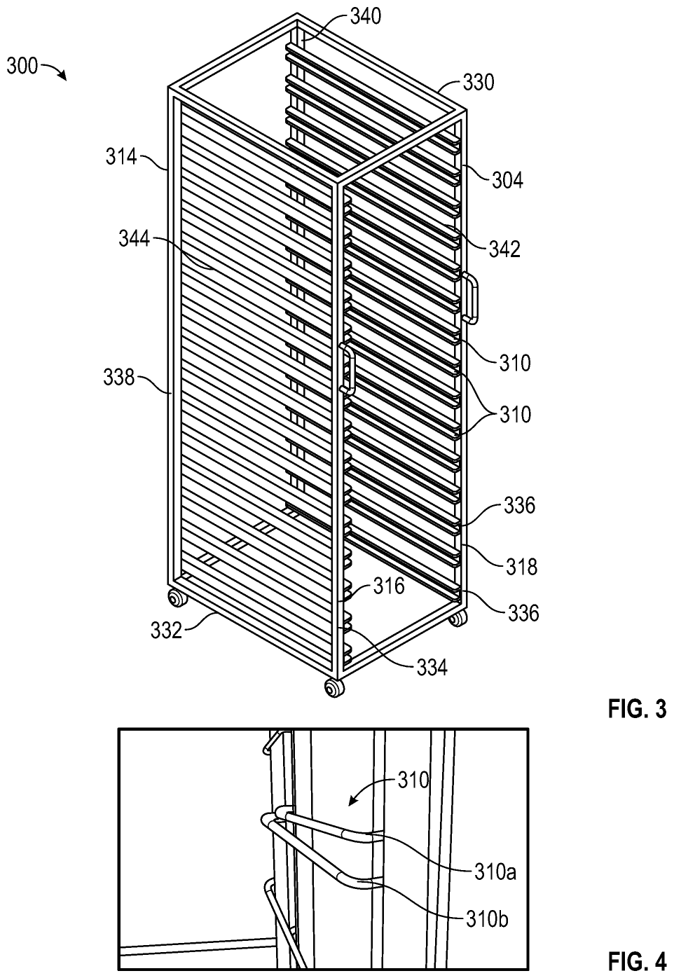

Referring also to FIGS. 3 and 4, the trolley 300 includes rails 310 along an inside of the trolley 300 to support trays 312 positioned thereon in the trolley 300. As used herein, the term “rack” will be used to define each layer of rail 310 or railing that accommodates one or more trays 312 at that layer or level. The rails 310 may be a solid strip or bar of material, such as steel or polymeric material, extending from the front 304 to a back 314 of the trolley 300. It can be seen that a width, from a left side 316 to a right side 318 of the trolley 300, taking into account the rails 310, is sized so as to accommodate the width of the trays 312. Similarly, a depth of the trolley 300, from the front 304 to the back 314 is similarly sized to accommodate the depth of the trays 312. In some embodiments, the trolley 300 is sized to accommodate one tray 312 per rack or level of rails 310, while in other embodiments the trolley 300 may be of sufficient depth to accommodate multiple trays 312 per rack. For example, in one present embodiment, the rails 310 and trolley 300 are sized to accommodate only one tray 312 per rack, while in other embodiments, two, three, or more trays 312 deep may be in each rack. The sizing of components of the trolley 300 may be based on a width and length of the trays 312 and whether the trays 312 will be inserted along their longest side, or “width-wise,” so called, or inserted along their shortest side, or “length-wise,” so called.

The size of the trays 312, and consequently the overall dimensions of the trolley 300, may be based on the food to be thawed, for example the size or number of pieces of food that are desired to be placed on each tray 312. Similarly, the height or vertical spacing of the rails 310 may depend of the height of the food to be thawed when placed on the trays 312. That is, smaller sized food and having a lower overall profile may be accommodated and sufficiently thawed within the desired time-frame in more compact vertical spacing of the racks and trays 312 as opposed to larger food products which may require fewer racks and trays 312 to provide sufficient spacing to accommodate the necessary air flow during the thawing process. Another consideration for the overall size of the thawing unit 100 is the size or dimensions of the openings through which the cabinet 200 and trolley 300 will need to pass. For example, the thawing unit 100 should be sized to be able to pass the doorway into the chiller room and the trolley 300 should be sized to move between the freezer where the froze food is kept, though hallways of the restaurant, and into the chiller room and into position in the cabinet 200. These food, system, and other sizing considerations will readily suggest themselves to one skilled in the art based on the present disclosure and are within the spirit and scope of the present disclosure.

As can be seen in FIG. 4, each rail 310 includes an upper and lower rail 310a and 310b, which may be beneficial for locating and positioning the trays 312 into the rack as well as providing stability. In other embodiments, only one rail 310, such as lower rail 310b may be used or some racks may include only a lower rail and other racks may include both upper and lower rails. Further, although fifteen (15) racks are shown in some of the disclosed embodiments, more or fewer rows may be uses. In other embodiments (not shown) the rails 310 may be adjustable, vertically, so that the spacing between trays 312 may be easily changed to provide for fewer or more racks of trays 312 depending on the size of the frozen food that needs to be thawed. Furthermore, rail 310 extensions, adapters, or spacers (not shown) may be provided to extend the rails 310 farther into the inner space 202 to accommodate trays 312 that are smaller or having a narrower width, which may be useful depending on the size of the frozen food to be thawed. In some embodiments, the rails 310 or racks may be substantially level, or positioned at the same height in the front 304 and back 314 of the trolley 300, while in other embodiment, the rails may be configured to slope downward from the from 304 to the back 314 to prevent the trays from sliding out of the trolley 300.

The trolley 300 is substantially a framed cage with a top box frame 330 and a bottom box frame 332 joined by a front left member 334, front right member 336, back left member 338 and back right member 340. The right side rails 342 extend between the front right and back right members 336, 340, while the left side rails 344 extend from the front left to the back left members 334, 338. The top and bottom box frames 330, 332 may be open in the center to promote air flow or may be covered or enclosed with a plate in some embodiments.

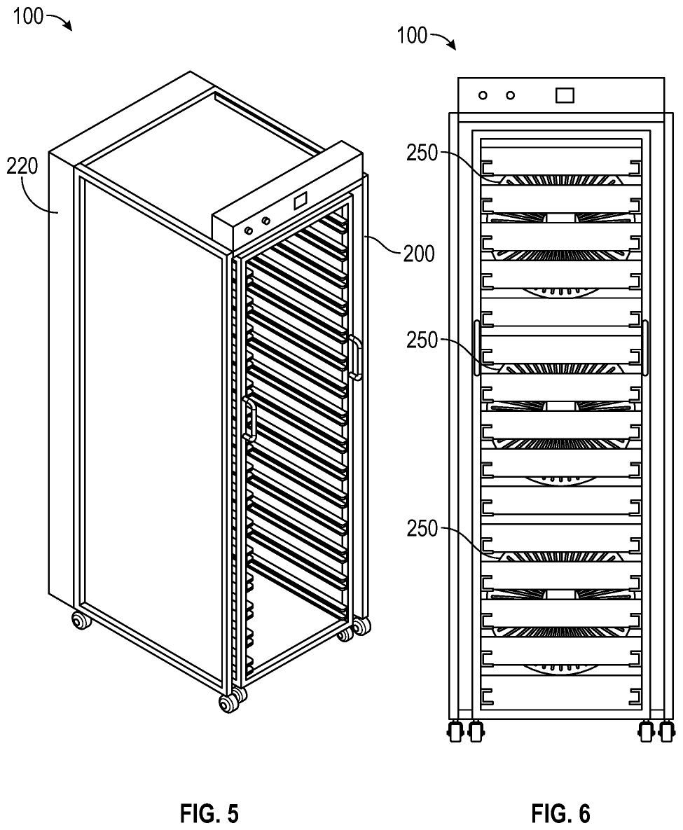

FIG. 5 illustrates another perspective view of the thawing unit 100 according to one embodiment. FIG. 6 illustrates a front view of the thawing unit 100 shown in FIG. 5. As can be seen in FIG. 6, a plurality of fans 250 are located on the back side 210 of the cabinet 200.

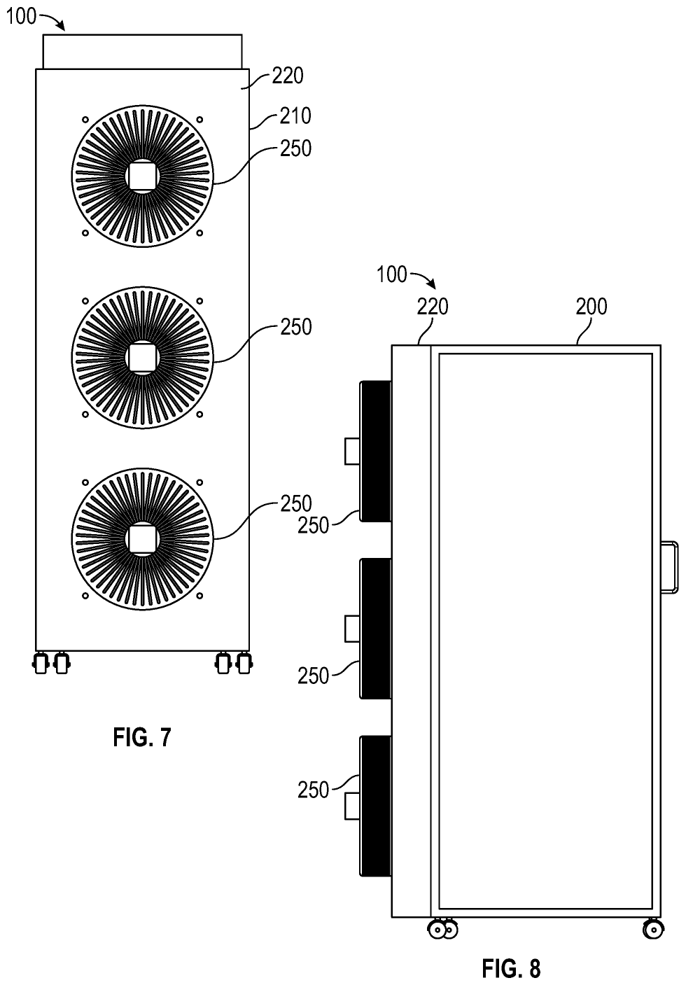

Referring also to FIGS. 7-8, back and side views of embodiments of the thawing unit 100 are illustrated. As can be seen in these illustrations, the door 220 mounted on the back side 210 of the cabinet 200 includes openings in communication with the inner space 202 of the cabinet 200. The fans 250 are located adjacent these opening in the door 220.

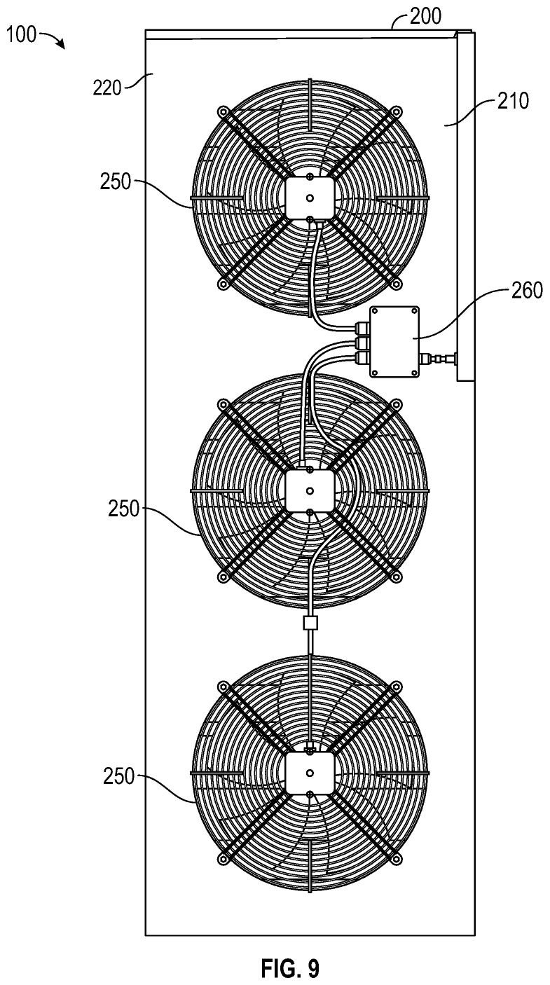

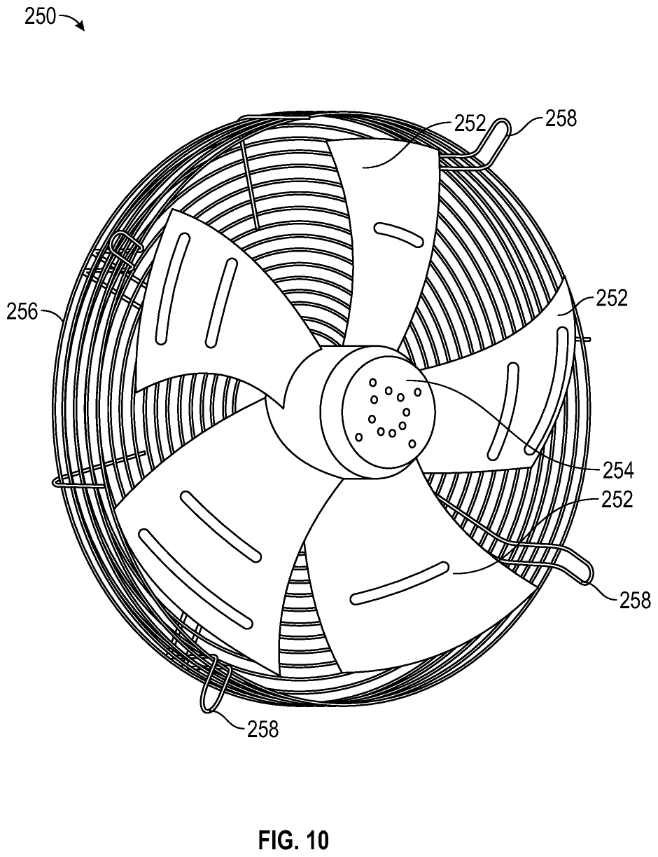

FIG. 9 illustrates another back view of the thawing unit 100 with fans 250 mounted to the door 220 on the back side 210 of the cabinet 200. Referring also to FIG. 10 a perspective view of an exemplary fan 250 that may be used in some of the disclosed embodiments is illustrated. The fans 250 may be an axial or propeller type fans that includes a plurality of blades 252. Other types of fans may be used in other embodiments. In this embodiment, each fan 250 may include five blades 252, but fewer or more blades 252 may be used in other embodiments. The blade 252 may be constructed from metallic or polymeric material. In this embodiment, the blades 252 are plastic, which may be preferred for cleaning and ruggedness. The fan 250 includes a motor 254 to drive the rotation of the blades 252. In this embodiment, the motor 254 is an electric motor of sufficient power to move the desired amount of air through the thawing unit 100 given the overall construction and design of the thawing unit 100. The motor 254 and fan blade 252 specifications are design choices which will readily suggest themselves to one skilled in the art. The fan 250 may also include a cage 256 that substantially surrounds at least a portion of the fan 250 to prevent contact with the blades 252 during operation. The fan 250 further includes mounting points 258 to enable a fixed attachment of the fan 250 to the door 220.

The fans 250 may be electrically powered via connection to a power coupling 260 or junction box provided on the door 220. The power coupling 260 may be connected to a wall outlet or other electrical system (not shown) available in the chiller room or elsewhere in the restaurant to provide the necessary electrical power for operating the fans 250, control system 400, and other systems of the thawing unit 100 requiring electrical power.

The present embodiment illustrates three fans 250 mounted on the door 220 of the cabinet 200, however other numbers and locations of fans 250 is anticipated and within the scope of the present disclosure. For example, while the fans 250 are illustrated as mounted in alignment with three openings provided in the door 220, the door 220 may be completely open, from the perspective of air flow, and a single larger sized fan 250 may be used or fewer or more than three fans 250 might be used depending on the type of food, placement of trays 312 and so on. Furthermore, the present disclosure anticipates embodiments where one or more fans 250 are located elsewhere, such as on top of the cabinet 200, and the fans 250 are placed in communication with adjacent ductwork in communication with the interior or inner space 202 of the cabinet 200 to draw air through the cabinet 200 and into the ductwork to promote thawing. These and other designs that provide for drawing ambient air from the chiller room and into the cabinet 200 across the trays 312 and food for thawing are anticipated and within the spirit and scope of the present disclosure.

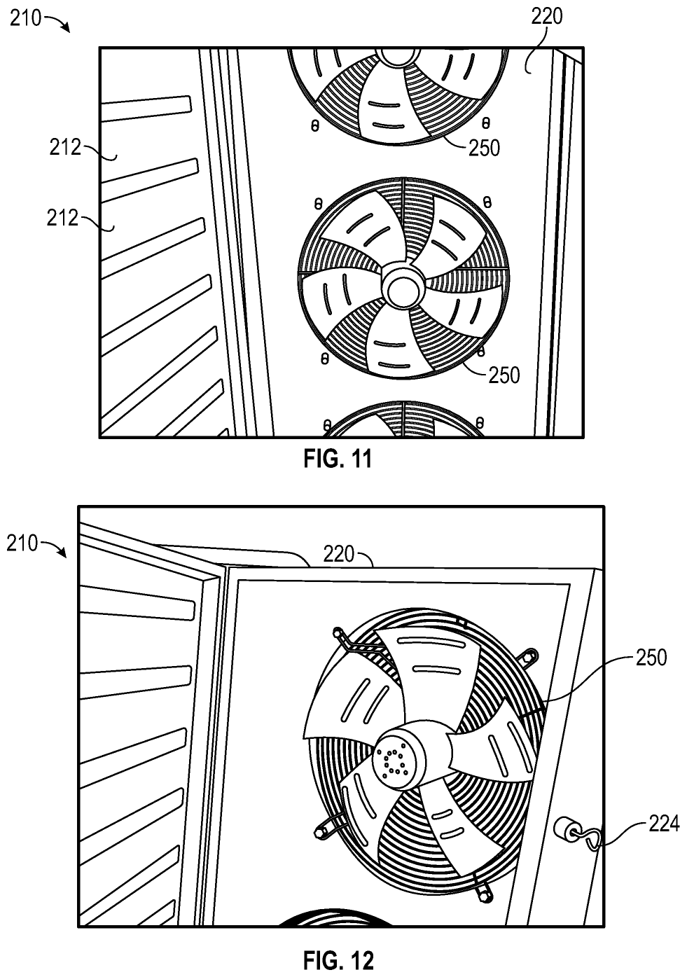

Referring to FIGS. 11 and 12, a back perspective view of one embodiment of the thawing unit 100 is illustrated with the door 220 on the back side 210 shown partially opened. The slats 212 on the back side 210 can be seen. In this embodiment, a plurality of slats 212 are show with sufficient spacing provided therebetween to promote drawing air through the inner space 202 of the cabinet 200 such that the fans 250 cause the air to exit the back side 210 of the thawing unit 100. Further, the slats 212 may provide structural integrity of the back side 210 of the thawing unit 100. In some embodiments, more or fewer slats 212 spaced closer or farther apart may be provided. In still other embodiments, the slats 212 may be omitted to prevent any obstruction of air flow.

As can be seen in these illustrations, the door 220 may be opened to allow for easy maintenance and cleaning of the back side 210 components, including the slats 212, fans 250, door 220, and so on. Although the door 220 is shown on a hinge system in this embodiment, the door 220 may be mounted to the back of the cabinet 200 in other manners which will readily suggest themselves to one skilled in the art. The door 220, in this embodiment includes one or more latches 224 for fixing the door 200 in a closed position during operation of the thawing unit 100.

In other embodiments, the slats 212 and door 220 may be omitted and the back side 210 may be comprised of substantially solid wall, such as the left side panel 204, with one or more openings sized to receive the fans 250 positioned adjacent thereto to draw air though the inner space 202 and exit the openings in back side 210 of the cabinet 200. In this case, personnel may clean the back side 210 by removing the trolley 200 and entering the inner space 202 of the cabinet 200.

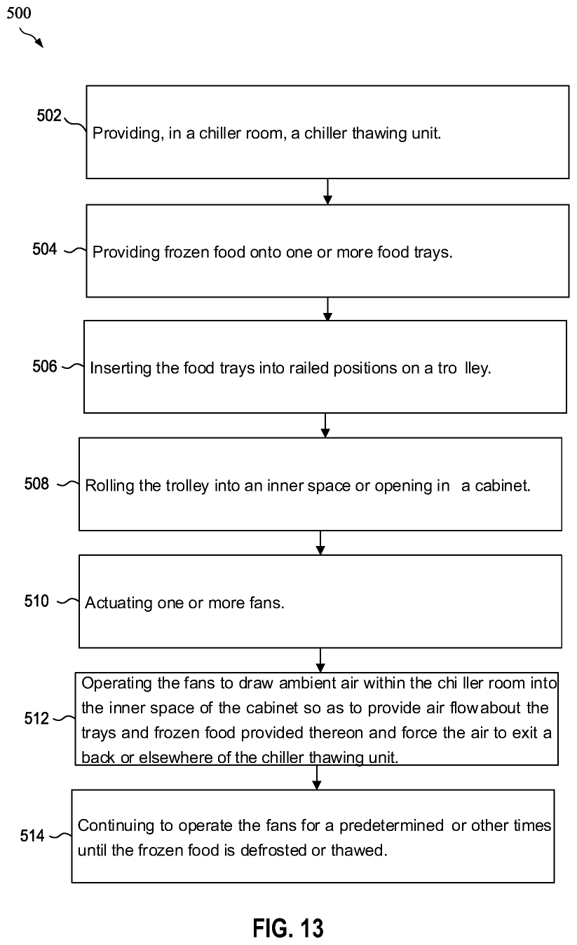

FIG. 13 is a flow chart 500 of a method for thawing food according to one embodiment. The method includes, at box 502, providing a chiller thawing unit in a chiller room, such as but not limited to, the thawing unit 100 described above. The method includes, at box 504, providing frozen food onto one or more food trays, such as trays 312. The method provides, at box 506, inserting the food trays 312 into railed positions on a trolley, such as trolley 300. The method includes, at box 508, rolling the trolley 300 into an inner space or opening in a cabinet, such as cabinet 200, of the thawing unit 100. The method includes, at box 510, actuating one or more fans, such as fans 250. The method provides, at box 512, for operating the fans 250 to draw ambient air within the chiller room into the inner space 202 of the cabinet 200 so as to provide air flow about the trays and frozen food provided thereon and draw the air to exit out the back or elsewhere of the thawing unit 100. It will be appreciated, that the thawing unit 100 is configured so that the front of the unit is open to the chiller room so there are not components or structures on the front of the unit to inhibit ambient air from the chiller room from entering the inner space 202 of the thawing unit 100. In some embodiments, this open front configuration promotes improved air flow about the frozen food and results in more even thawing of all the frozen food over a period of time.

The method further provides, at box 514, continuing to operate the fans 250 for a predetermined or other times until the frozen food is defrosted or thawed. For example, based on the air flow through the thawing unit 100, a predictable time may be estimated for achieving a thawed temperature of the frozen food after being placed in the thawing unit 100. While it may be useful to thaw frozen food quickly, such is difficult and expensive, as discussed above. Typically however, a restaurant is able to estimate the amount of food that will be needed on a daily basis. For example, a restaurant needing X pounds of food or X numbers of pieces of food may load the X pounds or X numbers of pieces of frozen food into the thawing unit 100 a predetermined number of hours in advance of needing the food to be thawed. These predetermined or known amounts may be placed in the thawing unit 100, for example, at 9:00 a.m. each morning knowing that the food will be thaw within, for example, 21 hours. In this way, the restaurant personnel are assured of having a known amount of thawed food early the next morning. In some embodiments, the air flow provided by the fans 250 may be adjusted to speed the thawing process. For example, adjustable fans, more fans, or larger fans may be used in other embodiments that are able to move more air or move the air faster through the thawing unit 100 in order to decrease the thawing time of the froze food when that is desirable. For example, in one embodiment, adjustable speed fans may be used and the speed of the fan may be selected based on the characteristics of the food to be thawed and the desired thawing time.

It will be appreciated that frozen food is typically provided in sealed packaging, such as in sealed plastic bags or pouches. This may complicate placement of the frozen food packages on the trays 312 because it may be beneficial, in some embodiments, for the entirety of the plastic bag containing the frozen food to be retained within the edges of the tray 312 so that as the food thaws any drips or condensation on the bags is retained within the trays 312 and does not drip or spill out onto the thawing unit 100 or onto floor of the chiller room. Further, the drip or condensation collected on the trays 312 may, in some embodiments, further promote efficient, time and uniformity, of thawing the frozen food. Again, this further highlights the need for appropriately sizing trays 312, and thus the overall size and configuration of the thawing unit 100 based on the size of the frozen food and packaging.

Furthermore, in one embodiment, the spacing between the racks, of railing 310 and trays 312, may be adjusted or configured to allow sufficient air flow over the frozen food at sufficient velocity to promote efficient thawing since too little space may constrict air flow and too much space may allow for increased volumes of air but at lower velocities that may slow the overall time required for thawing. These and other factors may be considerations used, in some embodiments, for determining the sizing and spacing of the racks in the chiller thawing unite 100 that will suggest themselves to one skilled in the art based on the present disclosure.

Thus, the thawing unit 100 may be configured, based on the known air flow and food type and distribution, to consistently and evenly thaw a given amount of food in a predetermined amount of time. These times may be obtained based on the known temperatures of the frozen food, ambient temperature in the chiller room, the characteristics of the frozen food, the air flow through the inner space 202 of the cabinet 200 based on the fan 250 sizes, and so on. In some cases, run time of the thawing unit 100 and thus the thawing time may be adjusted based on temperature measurements taken at various time intervals, and so on.

In one embodiment, the thawing unit 100 is turned on to actuate the fans 250 at time T1, such as 9:00 a.m., and turned off to at time T2, which may be a known time at which the amount of food loaded in the thawing unit 100 will be thawed. In some embodiments, the restaurant personnel may verify the temperature of the food to ensure the food is sufficiently thawed. The process of turning on and off the thawing unit 100 may be manually accomplished or may be controlled by a timer or computer system.

The method may also provide for maintaining the thawed food at a temperature of less than about 5° C. or at a temperature of about less than 4° C. and more preferably at a temperature of about 1-2° C. The method may further include providing a thermometer or other known temperature sensing device or system coupled to a computer system and dynamically measuring the temperature of the food. Based on the measured temperature, computer system may actuate the fans, for example, turn on, turn off, or the speed of the fans may be increased or decreased. The method may further provide for rolling or removing the trolley, trays, and/or thawed food from the chiller thawing unit. In still other embodiments the method may include repeating the above steps and/or employing multiple numbers of chiller thawing units simultaneously. In further embodiments, the method may include opening a back door of the chiller thawing unit for cleaning and maintaining the chiller thawing unit.

As discussed above, the present disclosure provides a thawing unit 100 that provides technical advantages over prior systems by providing uniform and even thawing of frozen food over a consistent time period. The disclosed system is inexpensive to construct relative to more complex microwave heat thawing systems and provides more consistent and uniform thawing relative to frozen food merely placed in chiller rooms. Further the present system may be sized larger or smaller as necessary to accommodate existing restaurant layouts, chiller room sizes, food sizes, and so on. Further, it is anticipated that multiple chiller thawing units may be used in situations where larger amounts of frozen food requires frequent thawing.

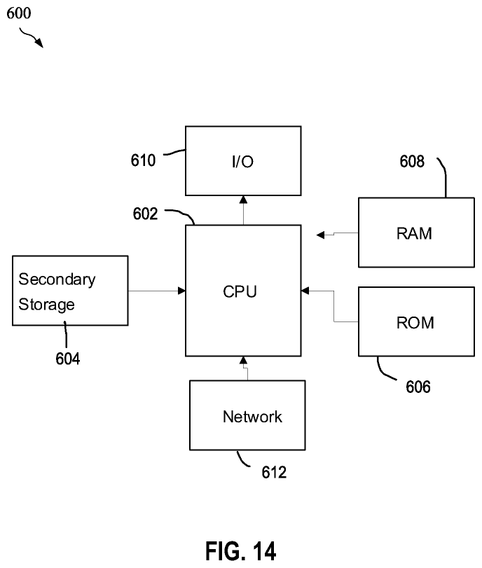

FIG. 14 illustrates a computer system 600 suitable for implementing one or more embodiments disclosed herein. For instance, thawing unit 100 (FIG. 1) and/or control system 400 may include or be coupled to computer system 600. During operation, the thawing unit 100 may utilize computer system 600 to receive and process operational instructions as described above. In some embodiments, one or more components of computer system 600 may be positioned within the control system 400 shown in FIG. 1.

The computer system 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips.

It is understood that by programming and/or loading executable instructions onto the computer system 600, at least one of the CPU 602, the RAM 608, and the ROM 606 are changed, transforming the computer system 600 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 600 is turned on or booted, the CPU 602 may execute a computer program or application. For example, the CPU 602 may execute software or firmware stored in the ROM 606 or stored in the RAM 608. In some cases, on boot and/or when the application is initiated, the CPU 602 may copy the application or portions of the application from the secondary storage 604 to the RAM 608 or to memory space within the CPU 602 itself, and the CPU 602 may then execute instructions that the application is comprised of. In some cases, the CPU 602 may copy the application or portions of the application from memory accessed via the network connectivity devices 612 or via the I/O devices 610 to the RAM 608 or to memory space within the CPU 602, and the CPU 602 may then execute instructions that the application is comprised of. During execution, an application may load instructions into the CPU 602, for example load some of the instructions of the application into a cache of the CPU 602. In some contexts, an application that is executed may be said to configure the CPU 602 to do something, e.g., to configure the CPU 602 to perform the function or functions promoted by the subject application. When the CPU 602 is configured in this way by the application, the CPU 602 becomes a specific purpose computer or a specific purpose machine.

The secondary storage 604 is typically comprised of one or more disk drives or tape drives and is used for non-volatile storage of data and as an over-flow data storage device if RAM 608 is not large enough to hold all working data. Secondary storage 604 may be used to store programs which are loaded into RAM 608 when such programs are selected for execution. The ROM 606 is used to store instructions and perhaps data which are read during program execution. ROM 606 is a non-volatile memory device which typically has a small memory capacity relative to the larger memory capacity of secondary storage 604. The RAM 608 is used to store volatile data and perhaps to store instructions. Access to both ROM 606 and RAM 608 is typically faster than to secondary storage 604. The secondary storage 604, the RAM 608, and/or the ROM 606 may be referred to in some contexts as computer readable storage media and/or non-transitory computer readable media.

I/O devices 610 may include printers, video monitors, liquid crystal displays (LCDs), touch screen displays, keyboards, keypads, switches, dials, buttons, mice, track balls, voice recognizers, card readers, paper tape readers, or other well-known input and output devices.

The network connectivity devices 612 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 612 may provide wired communication links and/or wireless communication links (e.g., a first network connectivity device 612 may provide a wired communication link and a second network connectivity device 612 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 612 may enable the processor 602 to communicate with the Internet or one or more intranets. With such a network connection, it is contemplated that the processor 602 might receive information from the network, or might output information to the network in the course of performing the above-described method steps. Such information, which is often represented as a sequence of instructions to be executed using processor 602, may be received from and outputted to the network, for example, in the form of a computer data signal embodied in a carrier wave. Thus, the present disclosure contemplates receiving instructions, such as customer orders received via online or so called internet applications or otherwise, via network connectivity devices 612, including orders for operation of the thawing unit 100 without input from employees or personnel located at or operating the thawing unit 100.

Such information, which may include data or instructions to be executed using processor 602 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 602 executes instructions, codes, computer programs, scripts which it accesses from hard disk, floppy disk, optical disk (these various disk-based systems may all be considered secondary storage 604), flash drive, ROM 606, RAM 608, or the network connectivity devices 612. While only one processor 602 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 604, for example, hard drives, floppy disks, optical disks, and/or other device, the ROM 606, and/or the RAM 608 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality described herein may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 604, to the ROM 606, to the RAM 608, and/or to other non-volatile memory and volatile memory of the computer system 600. The processor 602 may process the executable instructions and/or data structures in part by directly accessing the computer program product, for example by reading from a CD-ROM disk inserted into a disk drive peripheral of the computer system 600. Alternatively, the processor 602 may process the executable instructions and/or data structures by remotely accessing the computer program product, for example by downloading the executable instructions and/or data structures from a remote server through the network connectivity devices 612. The computer program product may comprise instructions that promote the loading and/or copying of data, data structures, files, and/or executable instructions to the secondary storage 604, to the ROM 606, to the RAM 608, and/or to other non-volatile memory and volatile memory of the computer system 600.

In some contexts, the secondary storage 604, the ROM 606, and the RAM 608 may be referred to as a non-transitory computer readable medium or a computer readable storage media. A dynamic RAM embodiment of the RAM 608, likewise, may be referred to as a non-transitory computer readable medium in that while the dynamic RAM receives electrical power and is operated in accordance with its design, for example during a period of time during which the computer system 600 is turned on and operational, the dynamic RAM stores information that is written to it. Similarly, the processor 602 may comprise an internal RAM, an internal ROM, a cache memory, and/or other internal non-transitory storage blocks, sections, or components that may be referred to in some contexts as non-transitory computer readable media or computer readable storage media.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A thawing system, comprising:
a cabinet having a substantially open front side, a back side, left side panel, right side panel, a top panel, and a substantially open bottom, an interior space of the cabinet defined by the back side, left and right side panels, and the top panel;
a trolley sized to be received in the interior space of the cabinet, the trolley including a plurality of horizonal rails positioned on inner left and right sides of the trolley and configured to receive a plurality of trays with food stuffs thereon;
one or more fans mounted adjacent to openings in the back side of the cabinet and configured to force air through the interior space of the cabinet and through the trolley; and
a control system operatively coupled to actuate the fans.

2. The thawing system of claim 1, wherein the cabinet includes a plurality of casters, and wherein the trolley includes a plurality of casters.

3. The thawing system of claim 1, wherein the trolley includes handles on a front side of the trolley.

4. The thawing system of claim 1, wherein the trolley further includes a front side and a back side, and wherein a first plurality of the plurality of horizontal rails are located on the inner left side of the trolley and extend from adjacent the front side to adjacent the back side of the trolley, and wherein a second plurality of the plurality of horizontal rails are located on the inner right side of the trolley and extend from adjacent the front side to adjacent the back side of the trolley.

5. The thawing system of claim 4, wherein the front side and the back side of the trolley are substantially open.

6. The thawing system of claim 1, wherein the top panel, the left side panel, and the right side panel of the cabinet substantially enclose each of a top side, a left side, and a right side of the cabinet.

7. The thawing system of claim 1, wherein the cabinet further comprises a door located on the back side of the cabinet, and wherein the door is provided with the openings, and wherein the one or more fans are each mounted to the door adjacent an opening of the openings.

8. The thawing system of claim 7, wherein the back side further includes a back wall of the cabinet, and wherein the back wall includes a plurality of support members extending from a left side to a right side of the cabinet on the back side of the cabinet.

9. The thawing system of claim 8, wherein the door is hinge mounted on the back side of the cabinet, such that when the door is opened the back wall is exposed.

10. The thawing system of claim 1, wherein the fans are configured such that when actuated, the fans draw air from the front side to the back side of the cabinet.

11. A method for thawing food stuffs, comprising:
providing a thawing unit in a chiller room, the thawing unit including a cabinet and trolley;
providing frozen food onto one or more food trays;
inserting the food trays onto rails in the trolley;
rolling the trolley into an inner space of the cabinet;
actuating one or more fans;
operating the one or more fans to draw ambient air within the chiller room into the inner space of the cabinet so as to provide air flow about the trays and food stuffs provided on the trays in the trolley; and
continuing to operate the fans until the food stuffs are substantially thawed.

12. The method of claim 11, where the fans operate to draw air from the chiller room into a front side of the cabinet and to exit a back side of the cabinet into the chiller room.

13. The method of claim 11, further wherein the thawing unit includes a control system in communication with the one or more fans and includes a timer and where the method further includes:
estimating an amount of food stuffs to be thawed;
estimating an amount of time to operate the fans to thaw the food stuffs; and
setting the timer to operate the fans the estimated amount of time.

14. The method of claim 11, wherein the cabinet includes a plurality of casters, and wherein the trolley includes a plurality of casters.

15. The method of claim 11, wherein the trolley includes handles on a front side of the trolley.

16. The method of claim 15, wherein the trolley further includes a back side, and wherein a first plurality of the plurality of the rails are located on the inner left side of the trolley and extend from adjacent the front side to adjacent the back side of the trolley, and wherein a second plurality of the rails are located on the inner right side of the trolley and extend from adjacent the front side to adjacent the back side of the trolley.

17. The method of claim 11, wherein the cabinet includes a top panel, a left side panel, and a right side panel that substantially enclose each of a top side, a left side, and a right side of the cabinet.

18. The method of claim 11, wherein the cabinet comprises a door located on a back side of the cabinet, and wherein the door is provided with one or more openings, and wherein the one or more fans are each mounted to the door adjacent one of the one or more openings.

19. The method of claim 19, wherein the back side of the cabinet further includes a back wall of the cabinet, and wherein the back wall includes a plurality of support members extending from a left side to a right side of the cabinet on the back side of the cabinet.

20. The method of claim 19, wherein the door is hinge mounted on the back side of the cabinet, such that when the door is opened the back wall is exposed.
